(19) United States
(12) Patent Application Publication
(10) Pub. No.: US 2002/0194162 A1
(43) Pub. Date: Dec. 19, 2002

(54) Method and system for expanding search criteria for retrieving information items

(76) Inventors: Vincent Rios, Ardsley, NY (US); Scott Robinson, Tarrytown, NY (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/859,190

(22) Filed: May 16, 2001

(51) Int. Cl. G06F 7/00

(52) U.S. Cl. 707/3

(57) ABSTRACT

A method and system for extracting and retrieving selected information items from a plurality of sources of information items is presented. User entered selection criteria are expanded using known variations of term elements within the selection criteria. Each of the expanded selection criteria terms are used to match information items stored at a plurality of information items sources. Information items that match the inputted, and expanded, selection criteria are then stored at a local site for further evaluation. Furthermore, matching information items are condensed by removing those same information items that were retrieved using different selection criteria.

### FIELD OF INVENTION

This invention relates to expanding search term criteria. More specifically, this invention relates to selectively expanding user-specified search criteria terms used to search informational databases stored on at least one computer, alone or in networks.

### BACKGROUND OF THE INVENTION

Computers and communication networks, such as the Internet, and Intranets, have changed the way information is conveyed to a host of users. Each day, new information items are added to databases located on computers and computer networks that provide information to a host of users. For example, the Internet and corporate Intranets have significantly changed the way people work and look for new employment. In this context, employers continuously add new employment positions and opportunities into databases of available employment positions.

Numerous sources have been developed, which enable employers and those seeking new employment to exchange information. For example, the Internet or corporate Intranets are a significant asset for providing links to sources of information items, such as candidate resumes and available employment positions. These sources maintain extensive information item resources, referred to herein as databases, which contain employer information about employment opportunities and available positions. Employers may also maintain local databases of current employees which may be searched to find employees with necessary skills, training or qualifications.

Specialized software, i.e., search engines, have been developed which enable users, employers or candidates to scan respective candidate or employer databases to find matches to specified search criteria. Using current search technology, the search for potential candidates or employers is an extremely manual and labor intensive process. The user typically must enter at least one proprietary identification code before access to a designated database is allowed and then must manually enter a sequence of keywords or search criteria, which are used to search a database of a designated source. After the keyword sequence or search criteria is entered and the search results are displayed, the user can then review the displayed results to find an opportunity that matches the requested search criteria. When a desirable opportunity is not found, then a new search may be initiated, using a different or broader set of search criteria. The search results for this newly entered search criteria will produce a different set, or an increased number of opportunities that must be reviewed, to determine whether a satisfactory opportunity has been found.

A user may further access additional sources of information items by manually logging on and reentering similar search criteria to disclose opportunities located at these sources. However, additional searches, using different sources, different data sources or databases may also disclose opportunities that were found on other sources of information items, as the same candidate or employer may be listed with more than one source.

Thus, current search technology is labor intensive and inefficient, as the resultant retrieved information items from each source must be reviewed and completely evaluated before a user can proceed to another source to conduct a new search. Additionally, the search results are not saved without some form of manual intervention. Additionally, the search results are highly dependent upon the user-entered keywords. In some cases, whole lists of candidates or employers may not be retrieved during a search because a particular keyword is not found in the database for candidates or employers.

Hence, there is a need to reduce the effort necessary to enter information that can be used among a plurality of sources of information items, to increase the efficiency of processing retrieved information items and to reduce the effort necessary in removing duplicate entries from search results.

### SUMMARY OF THE INVENTION

A method for selectively expanding inputted search criteria terms and retrieving information items distributed among a plurality of sources containing a plurality of information items associated with the expanded terms is presented. The method includes the steps of inputting at least one selection criteria, expanding the inputted selection criteria to include known variations of the inputted terms, translating the search criteria into a format acceptable to each source of information items and receiving information items that match the original and expanded search criteria. The received values are saved in a report of results for later review by a user. In another aspect of the invention, the received information items matching the selection criteria are filtered to remove repeated information items.

### BRIEF DESCRIPTION OF THE FIGURES

In the drawings:

FIG. 1 a illustrates an exemplary communication network;

FIG. 1b illustrates an exemplary login page;

FIG. 1c illustrates an exemplary keyword/category page;

FIG. 2a illustrates an exemplary search of a plurality of multiple sources in accordance with the principles of the invention;

FIG. 2b illustrates a flow chart of exemplary processing in accordance with one aspect of the present invention referred to in FIG. 2a;

FIG. 2c illustrates a flow chart of exemplary processing in accordance with a second aspect of the present invention;

FIG. 2d illustrates a flow chart of exemplary processing in accordance with a third aspect of the present invention;

FIG. 3a illustrates an exemplary expansion of search criteria in accordance with the principles of the invention;

FIG. 3b illustrates a flow chart of an exemplary processing in accordance with one aspect of the present invention as referred to in FIG. 3a;

FIG. 3c illustrates a flow chart of an exemplary processing in accordance with an aspect of the present invention as referred to in FIG. 3b;

FIG. 4 illustrates an exemplary reduction of duplicate entries in accordance with the principles of the invention;

FIG. 5a illustrates an exemplary verify sequence operation in accordance with the principles of the invention;

FIG. 5b illustrates an exemplary flow chart of verify sequence processing in accordance with the principles of the invention; and

FIG. 6 illustrates an exemplary flow chart of one embodiment of the invention.

It is to be understood that these drawings are solely for purposes of illustrating the concepts of the invention and are not intended as a definition of the limits of the invention. The same reference numerals, possibly supplemented with reference characters where appropriate, have been used throughout to identify corresponding parts.

### DETAILED DESCRIPTION OF THE INVENTION

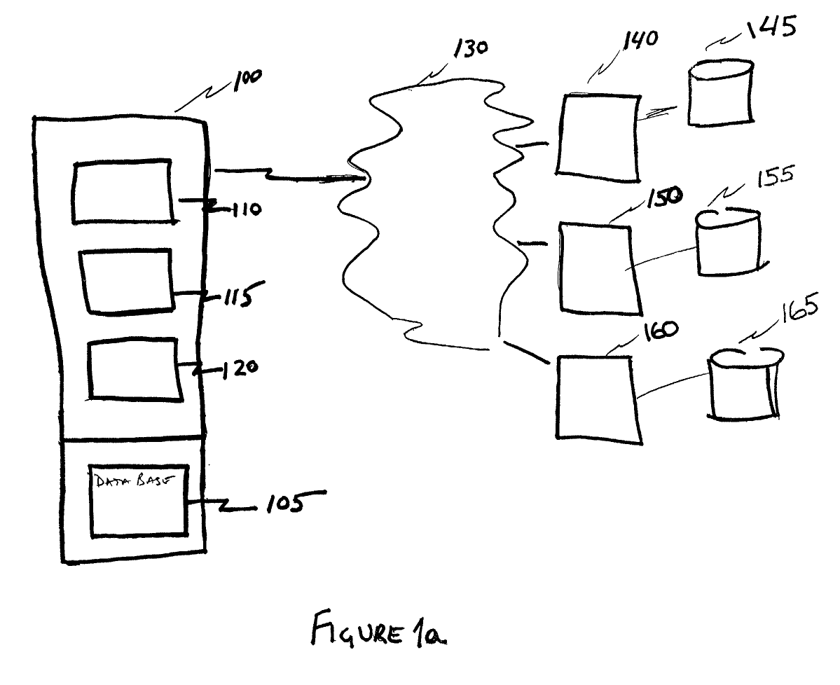

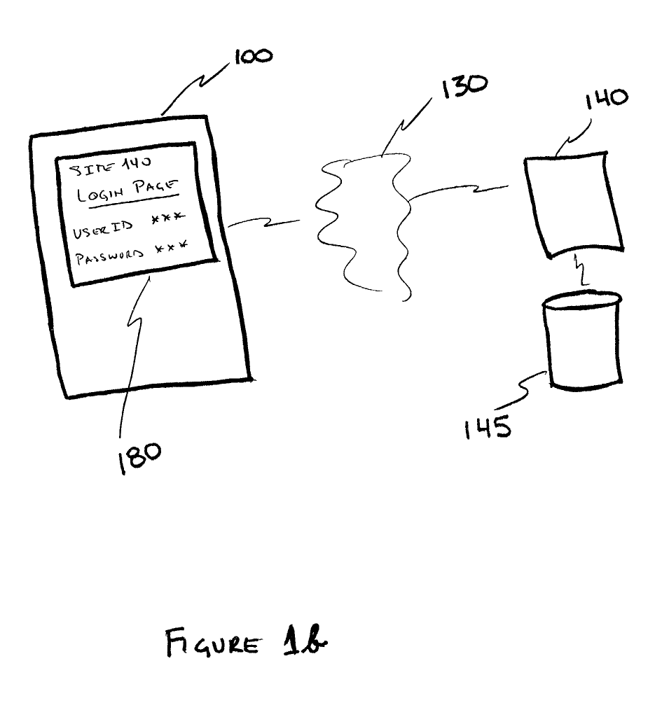

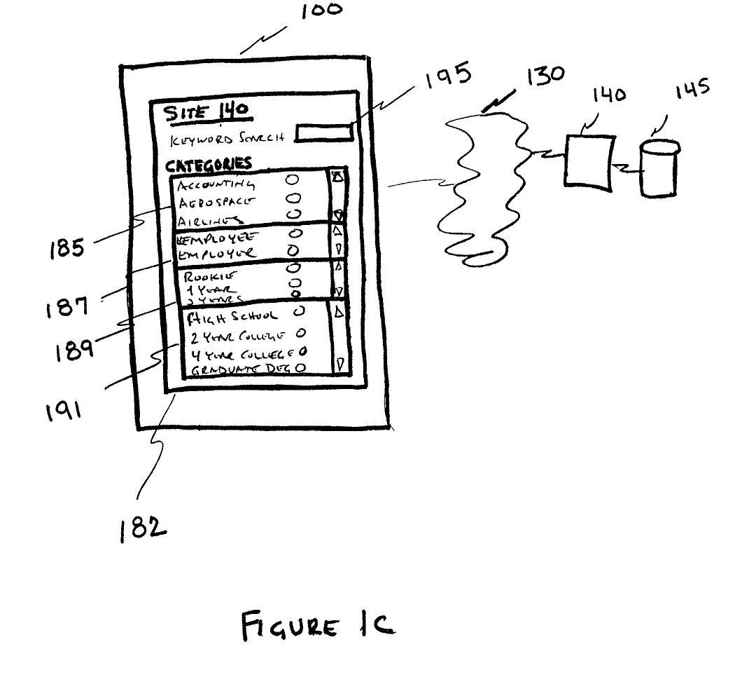

FIG. 1a illustrates an exemplary user site 100, for example, a computer system, in communication with illustrated sources 140, 150 and 160 over communication network 130. Sources 140, 150 and 160 further have access to databases 145, 155 and 165, respectively. Although not illustrated, one of skill in the art would realize that databases 145, 155 and 165 may be remotely located from sources 140, 150 and 160, respectively.

In searching for information items that are of interest to a user, a user using a computer system located at user site 100, may access source 140 using, for example an Internet protocol, by supplying an appropriate Universal Resource Locator (URL) for source 140. Source 140 may then request a registration or login page, which requires a user to enter a known user identification and password, as represented by block 110, for access to the information items in database 145. Similar, independent, login operations for illustrated sources 150 and 160 may also be required, as represented by blocks 115 and 120, respectively, before access to information items in databases 155 and 165, respectively, is allowed. Further still, site 100 can be a source of information items by maintaining a local database 105 of information items that can be searched. Access to local database 105 may also require a special login sequence, password, etc.

FIG. 1b illustrates an exemplary login screen 180 that a user must complete before access to the informative sections of source 140 is allowed. After source 140 verifies the user as a registered user, the user can be presented with a plurality of keyword entry fields, and/or search term entry fields and categories that aid the user in searching, in this illustrative case, database 145.

FIG. 1c illustrates an exemplary keyword/category selection screen provided by source 140 to a user on user site 100. In this case, source 140 provides keywords, such as “accounting” “airlines”, etc., in category “occupational field” 185, keywords “employer” and “employee” etc., in category “type of employment” 187, keywords “1 year” “3 years” etc., in category “experience” 189, and keyword “high school”, 2 year college, etc, in category “education” 191.

FIG. 1c further depicts field 195, which enables a user, in this illustrative example, a candidate seeking employment, to input at least one search term that may be used to provide more specific criteria used for searching a respective database. After the user has entered an appropriate keyword in selected categories, or entered specific search terms, source 140 accesses entries in database 145 to extract entries that match the inputted selection criteria. For example, the user may enter search criteria to find employers within 50 miles of New York City that have positions that require “Visual Basic” programming skills. The results of the search by source 140 of the entries contained within database 145 are then provided to the user for review. The user, after reviewing the returned matching results, may broaden or narrow the search results. For example, a user may broaden the search to include employers requiring “Basic” programming or narrow the search to include only employers that require “Visual Basic” and “Power Builder” programming skills. Hence, the user must re-enter the amended criteria to obtain a second list of available positions. The user may also request sources 150 and 160 perform searches using similar criteria. Returning to FIG. 1a, data packet 110 is representative of search criteria that is manually entered to request a search of data available to source 140. Data packet 115 is representative of search criteria that a user manually enters to request a search of data available to source 150 and data packet 120 is representative of search criteria that a user manually enters to request a search of data available to source 160. Although, the examples contained herein are representative of a candidate searching sources of information items seeking new employment, it should be obvious to one skilled in the art that employers, having available positions, may also search sources of information items seeking prospective candidates.

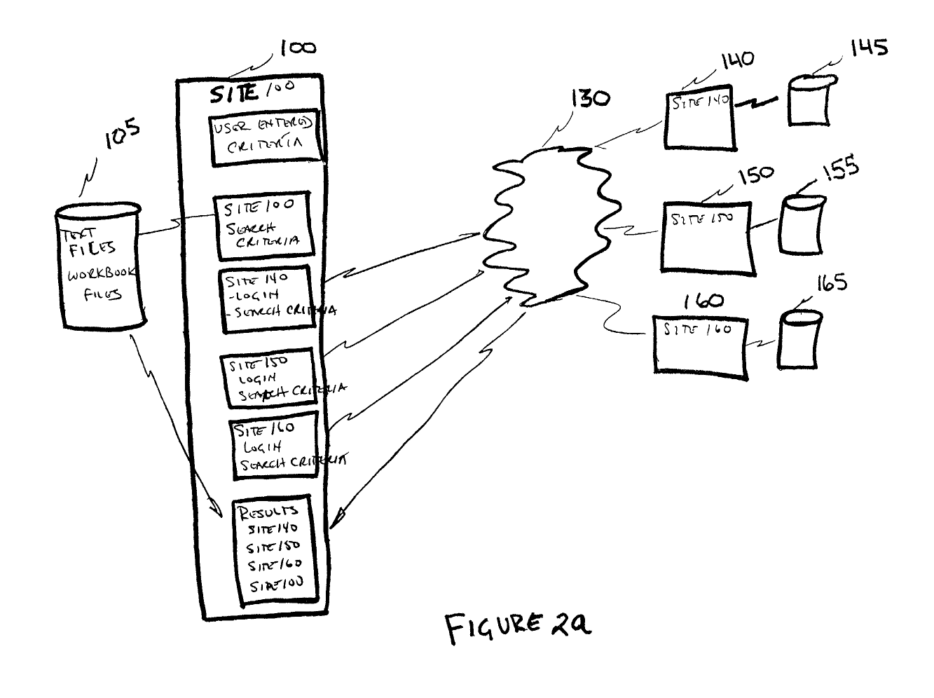

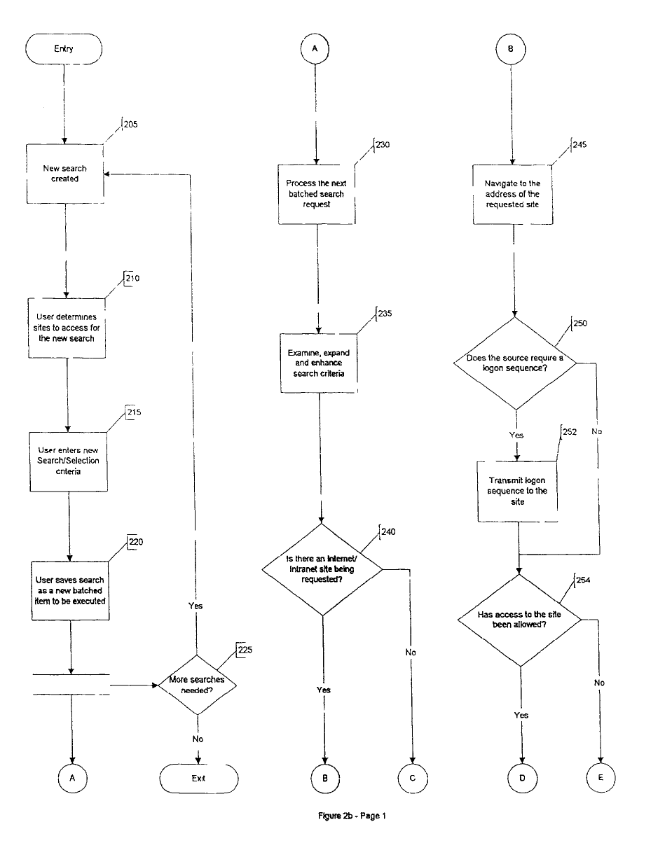

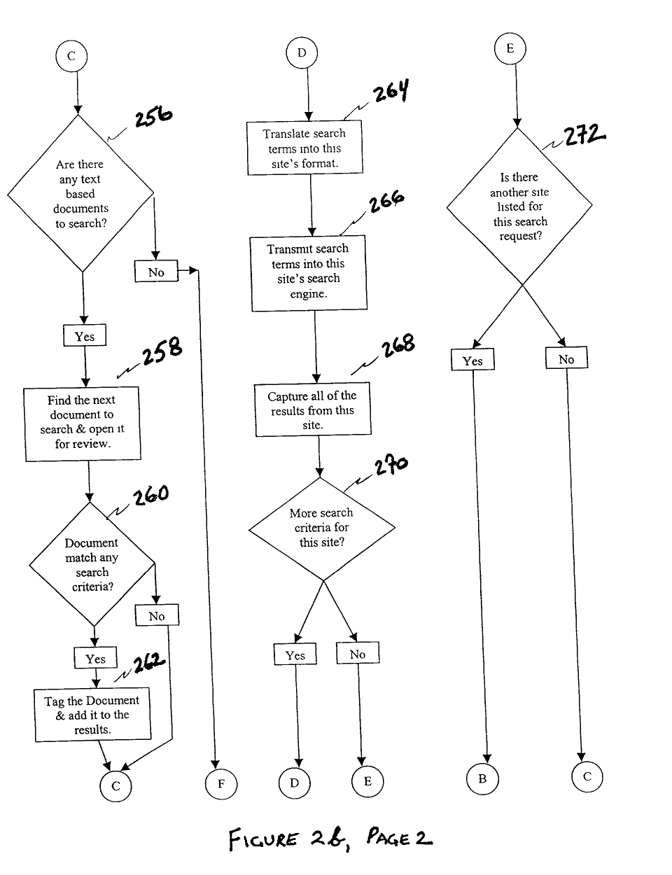

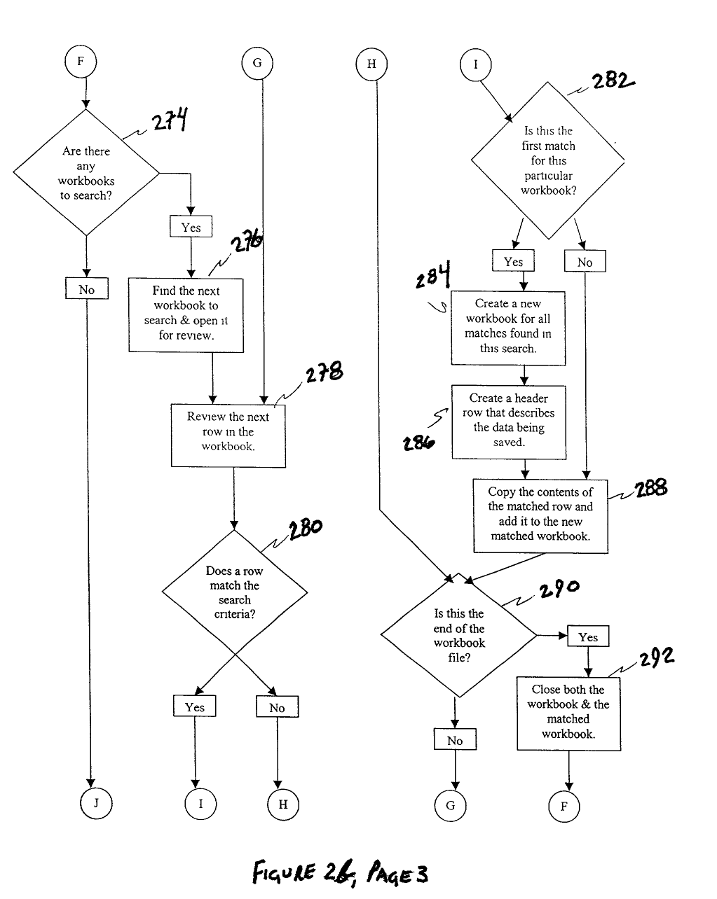

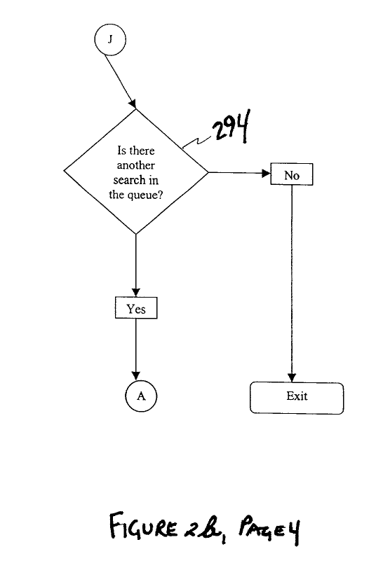

FIG. 2a illustrates an exemplary user search transaction in accordance with the principles of the invention. In this illustrated example, a user enters search criteria at user site 100, which are then used in connection with a plurality of designated sources of information items. The user-entered search criteria are generically related search terms for a desired position, opportunity or qualification. In accordance with the principles of the invention, for each of a plurality of designated sources, a corresponding login sequence is executed, if necessary, and the generically entered search criteria are interpreted, expanded, and enhanced and ultimately translated into a proprietary format required by each of the sources.

For example, a user may enter generically related search criteria at user site 100 and then request access to, and search the information items of designated sources, illustrated as sources 140, 150 and 160. In illustrative example, source 140 is known to require registration and, in accordance with the principles of the invention, a known login sequence, proprietary to source 140, is issued which, when verified, allows access to data maintained by source 140 (i.e., information items in database 145). The terms in the generically entered search criteria are interpreted, expanded, enhanced and ultimately translated into the required proprietary format specific to source 140. Each of the translated search criteria (e.g., keywords/categories) are progressively transmitted to source 140. The results of the search are returned to user site 100 and recorded at the user's local computing system or network for later reference.

A second designated source, for example source 150, is then automatically selected. Similarly if source 150 requires a registration, then a login sequence, proprietary to source 150 is issued, which, when accepted, allows access to the illustrated database 155 available to source 150. The terms of the generically entered search criteria are then interpreted, expanded, enhanced and ultimately translated into the required proprietary format specific to source 150. The translated search terms (e.g., keywords/categories) are then transmitted to source 150. The results of the search are returned to user site 100, and are added to the previously obtained results, in this case, from source 140. Repeated resultant entries are removed by matching known elements among the search results, such as name, telephone number, electronic mail (e-mail) address, etc. The consolidated search results are recorded for later reference.

In this illustrated example of the principles of the invention, a third designated source, site 160, is then automatically selected. Again, as previously discussed, a login sequence, proprietary to source 160, is issued, if required, to allow access to information items contained on illustrated database 165. The terms of the generically entered search criteria are then interpreted, expanded, enhanced and ultimately translated into the required proprietary format specific to source 160. The translated search terms (e.g., keywords/categories) are then transmitted to source 160. The results of the search are returned to user site 100, and added to the previously obtained search results, in this illustrative example, from sources 140 and 150. Further, search results are checked for repeated entries. Repeated entries are then removed and a consolidated list of search results is recorded.

After each of the designated sources of information items have been searched and the results accumulated, if previously designated, a search of local files containing informational items is performed. If local files are available, e.g. text files, as represented by database 105, then, the terms of the generically entered search criteria are then interpreted, expanded, enhanced and ultimately translated into the required proprietary format specific to database 105 and the results of the search are appended to the accumulated results, after removal of any duplicated items.

FIG. 2b illustrates an exemplary flow chart of processing in accordance with the method illustrated in FIG. 2a. In this exemplary processing, a new search is created at block 205. At block 210, a user designates at least one site or source from which information items are desired. At block 215, a user enters generic search terms. At block 220, the user saves the search as a new batched item to be executed. If the user decides to batch additional search requests (block 225), he/she may do so (block 205) without waiting for the results of a previously submitted search request.

At block 230, the next batched search request is automatically selected for processing. The search terms of the selected search request are then examined, expanded and enhanced using known variations of the terms at block 235.

At block 240, a determination is made as to whether the source of information items is accessible through a communication network, such as the Internet, or an Intranet. If the answer is in the affirmative, then the invention navigates to the address (URL) of the requested source at block 245.

At block 250, a determination is then made whether the requested source of information items requires a login sequence. If so, then the user login sequence specific to the requested source is transmitted to the requested source, at block 252. The process next determines, at block 254, whether access to the requested source has been allowed. If so, a first/next enhanced and expanded selection criteria is translated into a format compatible with that of the requested source, at block 264. The translated selection criteria are then transmitted to the requested site across the communication network, at block 266. At block 268, the results of the search of the requested information item source are returned and accumulated at the requester station, i.e., local site. At block 270, a determination is made whether more search criteria, e.g., expanded criteria, are available for the currently requested site. If so, then the next search criteria are translated into a format compatible with that of the requested source, at block 264.

If the answer at block 270, however, is negative, then a determination is made, at block 272, whether another source of information items is available, i.e., was previously designated. If the answer at block 272 is in the affirmative, then the invention automatically navigates to the address (URL) of the next requested source (block 245) and, the illustrated process is repeated for each expanded search criteria transmitted to each designated source.

If, however, the answer, at block 272 is negative, then a determination is made, at block 256, whether any text-based documents are to be searched. If the answer is in the affirmative, then a first/next text document is selected and reviewed, at block 258. At block 260, a determination is made whether the selected document contains information items that match the search criteria. If so, the selected document is added, at block 262, to the results obtained from previous searches. The process then repeats the process steps of determining, at block 256, whether additional text based documents are to be searched and processes these documents, at blocks 258, 260 and 262, as described.

If, however, no additional documents are available to be searched, as determined at block 256, then a determination is made at block 274, whether any workbooks containing information items are designated to be searched. Workbooks are conventional spreadsheet documents, such as can be developed using application programs such as MICROSOFT EXCEL or LOTUS. If workbook documents are designated, then the first/next workbook is selected and opened for review, at block 276. A first/next row in the selected workbook is selected at block 278. A determination is made, at block 280, whether the information items in the selected row match any search criteria. If so, then a determination is made at block 282, whether this is the first match of the selected workbook. If so, then a new workbook is created, at block 284, to collect the matching information items. A header row that describes the data is included in the newly created work book, at block 286. At block 288, the matching information items are copied to the newly created workbook.

At block 290, a determination is made whether the last row of the currently selected workbook has been reached. If so, then the currently selected workbook and the new workbook are closed, at block 292, and a determination is made at block 274 whether a next workbook is available to be searched. If so, then processing of workbooks continues, as previously described.

If, however, the answer to the determination at block 290, is negative, i.e., more rows are available to a selected workbook, then the next row in the workbook is selected. The processing of the row continues as previously described.

Returning to the determination executed at block 282, if the answer is negative, i.e., not the first entry in the newly created workbook, then the contents of the matching row are copied to the newly created workbook, at block 288. The processing continues at block 290, as previously described.

Returning to the determination executed at block 274, if the answer is negative, i.e., no more workbooks available to search, then a determination is made at block 294, whether another search is available. If another search is available, the next batched request is selected at block 230.

If, however, no other searches are available, then the process is ended. As should be obvious to anyone skilled in the art, the illustrated process repeats for each expanded search criteria that is transmitted to each designated source.

FIG. 2c illustrates a flow chart of a second exemplary processing in accordance with the method illustrated in FIG. 2a. In this exemplary processing, the same, known, at least one designated source of information items is pre-established by a user. The same, known at least one designated source can be established, for example, by maintaining a list of sources. Thus, the same sources are searched using the search criteria entered at block 215. Processing, in this case, continues in a manner as previously described with regard to FIG. 2b.

FIG. 2d illustrates a flow chart of a third exemplary processing in accordance with the method illustrated in FIG. 2a. In this exemplary processing, the same, known, at least one designated source of information items and search criteria terms are pre-established by a user. The same, known at least one designated source and search criteria can be established, for example by maintaining a list of sources and search criteria. Processing, in this case, continues in a manner as previously described with regard to FIG. 2b.

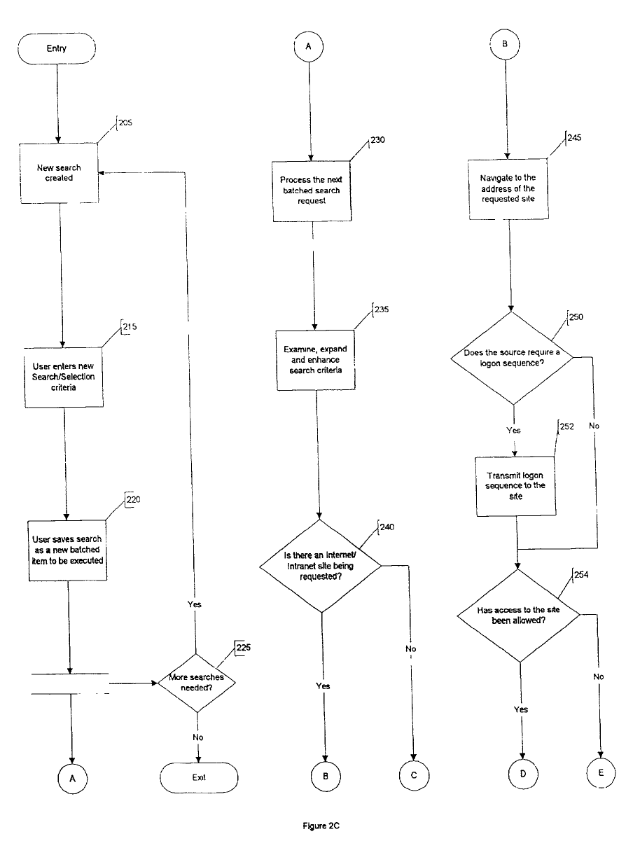

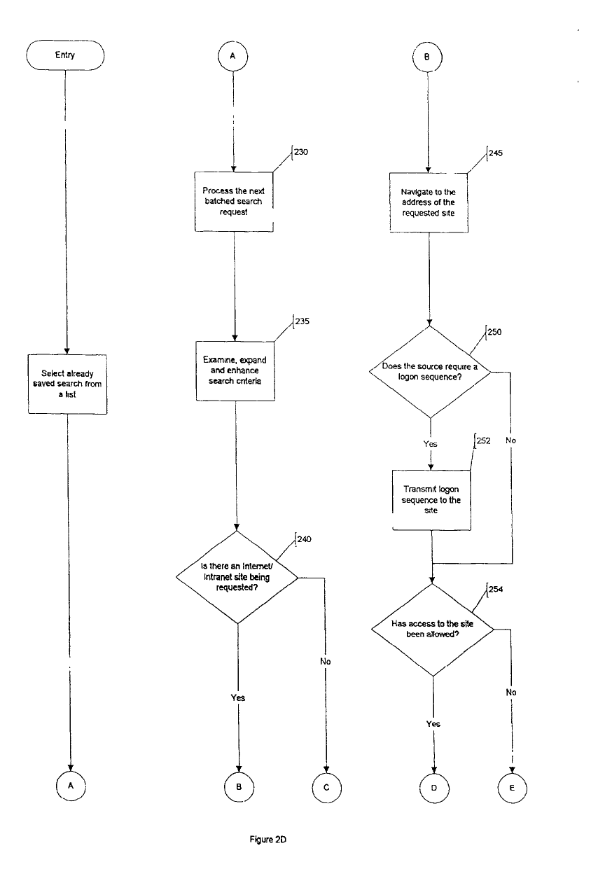

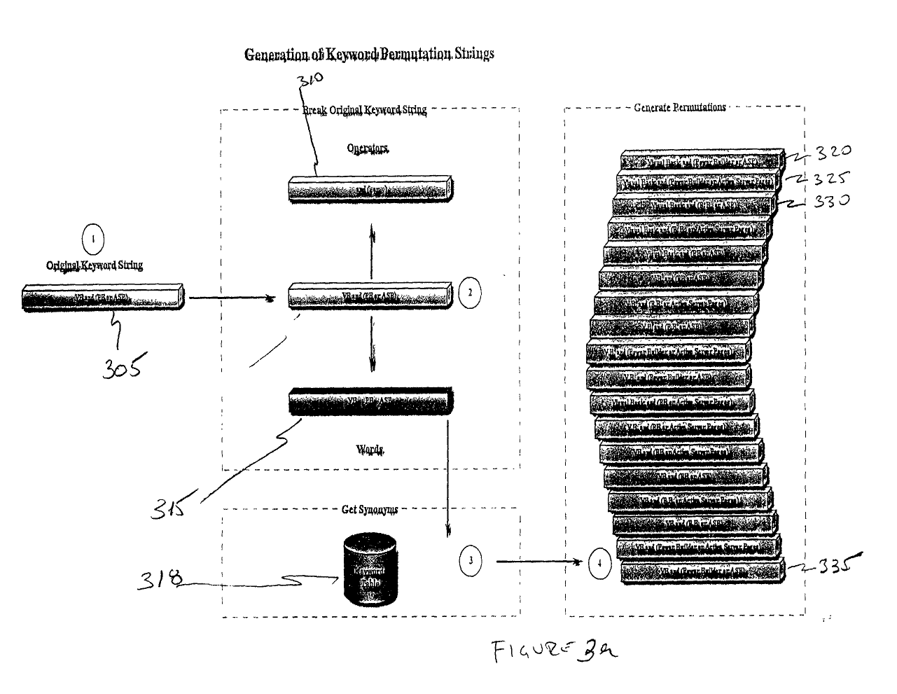

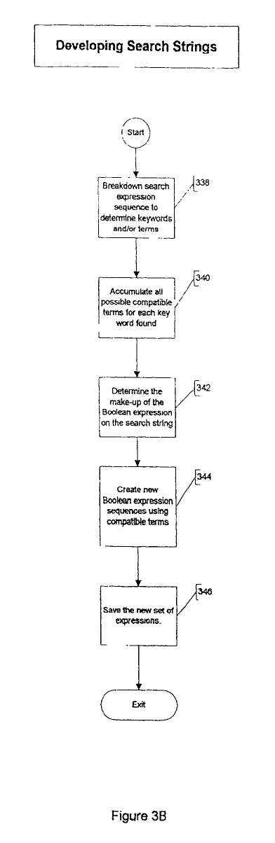

FIG. 3a illustrates an exemplary expansion of a user-entered search criteria in accordance with the principles of the invention. In this illustrative example, the search criteria “VB and (PB or ASP)”, as represented by block 305, is entered by a user. The user-entered search criteria are decomposed into logical operators “and (or)” at block 310 and specific terms “VB”, “PB”, and “ASP” at block 315. Synonyms or compatible terms of the specific words are then determined from database 318. For example, specific term “VB” may be expanded to “V.B.” and “Visual Basic.” Similarly, “PB” may be expanded to “P.B.” and “Power Builder” and “ASP” may be expanded to “A.S.P.” and “Active Server Pages.” Hence, the user-entered search criteria may be expanded and enhanced to include criteria, such as “Visual Basic and (Power Builder or ASP)” 320 “Visual Basic and (Power Builder or Active Server Pages)” 325, “Visual Basic and (P.B. or ASP)” 330 etc.

Table 1 illustrates, an expansion/enhancement of the user-entered search criteria “(Visual Basic OR Power Builder) AND Oracle”:

TABLE 1
Expansion of Selection Criteria

| ENTERED SELECTION CRITERIA | EXPANDED SELECTION CRITERIA |
|---|---|
| (Visual Basic or Power Builder) AND Oracle | (Visual Basic OR P.B.) AND Oracle |
| | (Visual Basic OR PB) AND Oracle |
| | (Visual Basic OR PowerBuilder) AND Oracle |
| | (V.B. OR P.B.) AND Oracle |
| | (V.B. OR PB) AND Oracle |
| | (V.B. OR Power Builder) AND Oracle |
| | (V.B. OR Power Builder) AND Oracle |
| | (VB OR P.B.) AND Oracle |
| | (VB OR PB) AND Oracle |
| | (VB OR Power Builder) AND Oracle |
| | (VB OR PowerBuilder) AND Oracle |

FIG. 3b illustrates a high level processing flow chart enhancing and expanding search criteria in accordance with the principles of the invention. As illustrated, keywords or search terms are determined from the search criteria expression or sequence, at block 338. At block 340, compatible terms for each of the keywords or search terms are then determined and accumulated. At block 342, the Boolean elements of the search criteria are determined. At block 344, new search criteria expressions are created using the accumulated compatible terms and the search criteria expression Boolean elements. At block 346, each of the created, enhanced and expanded search criteria are saved.

FIG. 3c illustrates a flow chart of an exemplary processing of expanding selection criteria in accordance with the principles of the invention. Upon entry, a user enters, at block 350, generic selection criteria. The search terms are isolated from the logical, i.e., Boolean, expressions that link the search terms together, at block 355. At block 360, the first/next term is selected. At block 365, a determination is made whether any known compatible terms exist. If the determination is in the affirmative, then the next compatible term for the selected search term is obtained at block 370. At block 375, a determination is made, whether the list of compatible terms for the selected search terms have been exhausted. If the determination is in the negative, then the next compatible term for the selected search term is obtained at block 370 and the processing continues as previously described.

If the determination at block 375 is in the affirmative, and therefore, no additional compatible terms for the selected search term are available, a determination is made at block 380, whether all search terms have been processed. If the determination is in the negative, then the next search term is selected from among the isolated search terms at block 360 and the processing continues as previously described.

If however, the determination at block 380 is in the affirmative, i.e., all search terms have been processed, then the expanded selection criteria are constructed using the compatible terms and logical operators at block 385.

If however, the determination at block 365 is in the negative, then a determination is made at block 380, whether all search terms have been processed. If the answer is in the negative, then the next search term is obtained at block 360 and the processing continues as previously described.

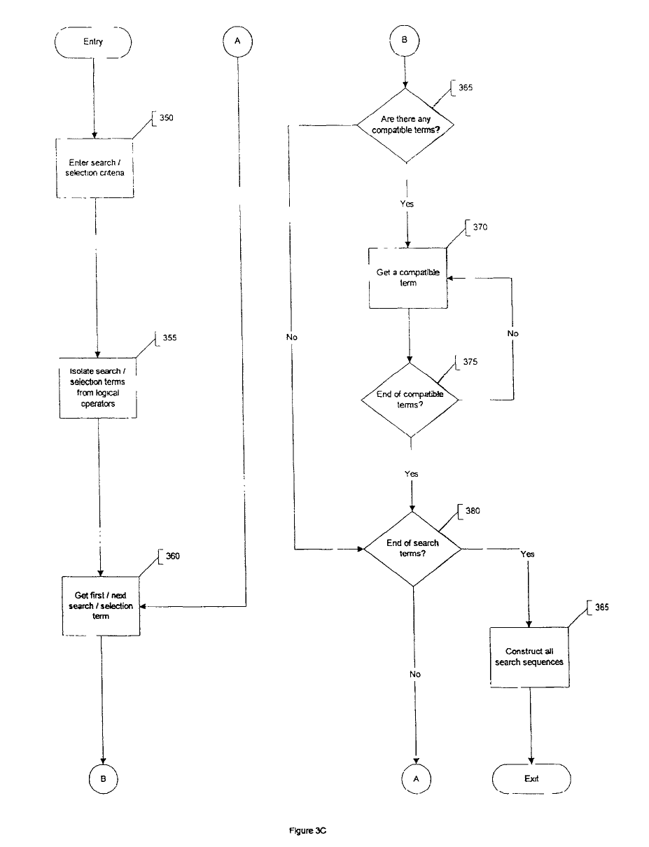

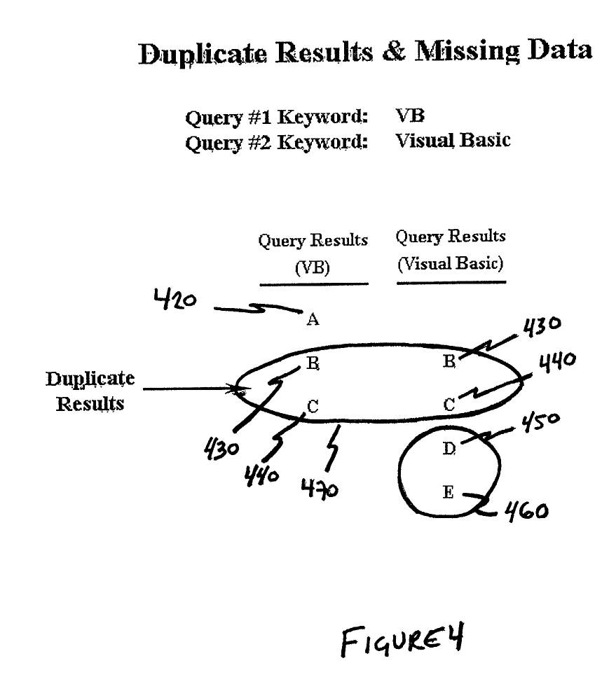

FIG. 4 illustrates search results received in response to multiple queries (i.e., search requests) using the exemplary search term “VB” in a first request and an expanded search term “Visual Basic” in a second request. In this illustrative case, the information items retrieved corresponding to the search term “VB” are labeled A 420, B 430 and C 440. The information items retrieved corresponding to the search term “Visual Basic” are labeled B 430, C 440, D 450 and E 460. In this illustrative example, information items B 430 and C 440 are retrieved twice, as the retrieved information items B 430 and C 440 contain the search terms, “VB” and “Visual Basic.”

This duplication of retrieved information items is burdensome as it requires a user to review each retrieved result, recall matching entries and discard duplicate entries. In accordance with the principles of the invention, retrieved information items for each search request are analyzed for matching entries and matching information items are removed. Matching entries are determined from at least one criteria selected from a group of criteria, such as name, address, contact telephone number, facsimile number, e-mail address, etc. Thus, at the conclusion of the duplicate removal process, a single one of each retrieved entry remains to be recorded. In this example, items A 420, B 430, C 440, D 450 and E 460 are recorded and made available to a user. The user has the further ability to manually link results, which may then be used to determine duplicate entries.

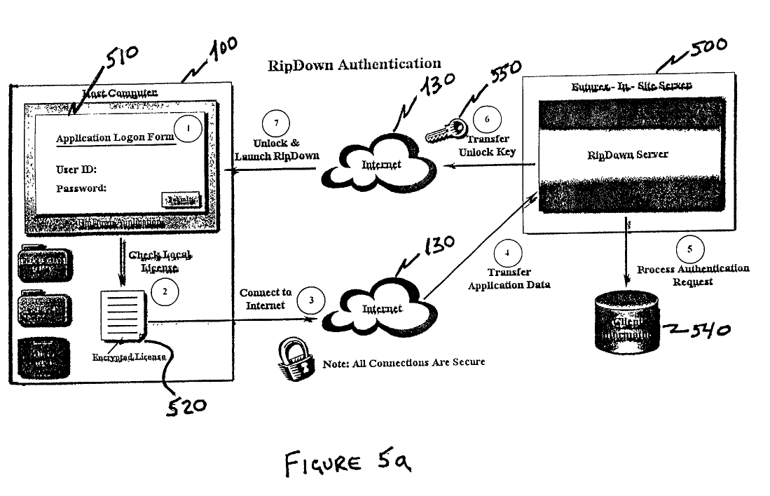

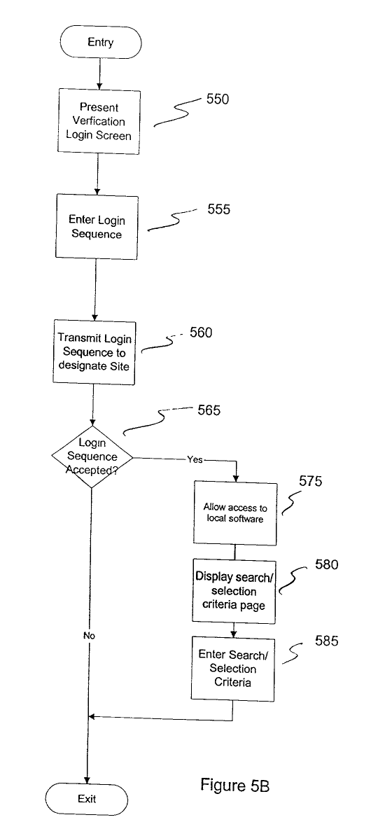

FIG. 5a illustrates a further aspect of the present invention, wherein a verification of a user initial access, or login, to the present invention is illustrated. In this case, a user, at user site 100, is presented a verification or login screen 510. After the user enters an appropriate verification sequence, for example, user identification name and password, the entered information is then transmitted over communication network 130 to remotely located site 500. As illustrated, the transmitted user name and password may be encrypted using encryption software 520, which is well known in the art. At site 500, the entered verification sequence, e.g., user name and password, are validated by being compared to a list of registered users stored on database 540. When it is determined that the user is registered, an unlock key, code or sequence 550 is returned to user site 100. Unlock code 550 when received by the transmitting program enables the user to proceed with operation of the local software. In this case, entering selection criteria.

FIG. 5b depicts an exemplary processing of a verification sequence to allow access to use the present invention. In this illustrative example, upon entry, an initial login screen is presented to the user, at block 550. The user is requested to enter a login or verification sequence, for example, name and password, at block 555. As would be appreciated the login or verification sequence maybe similar to, but is not necessarily the same as, the login sequences required by each of the sources of information items discussed herein. In this case, the acceptance of a login or verification sequence allows access to software that is located on the user's local computing system. At block 560, the login sequence is transmitted to a site over communication network 130 that is designated by the local software package. As previously discussed, the designated source, 500 in FIG. 5a, performs a check of the login sequence with regard to information stored on database 540. At block 565, a determination is made whether the login sequence is acceptable. If not, then the user is denied access to the local software package. If, however, login sequence is acceptable, then an unlock key, code or sequence returned the software package enables access to the local software package at block 575. In this illustrative example, the user may then be presented with a search selection screen at block 580 and enter search or selection criteria at block 585. As can be seen, the local software package, to which access is allowed upon receiving a unlock key, code or sequence, is not limited to the search criteria expansion method disclosed herein. Rather, the unlock key may be used to allow access to documents, such as text or spreadsheets, that are protected using a verification sequence stored remotely.

Although the present invention has been illustrated as obtaining information items associated with desired selection criteria among a plurality of information sources in communication via a communication network, it should be appreciated that the present invention may also be used on a local computer or on a local area network. For example, in one embodiment of the invention a corporation, company or firm, may have a single source or a plurality of sources of information items, such as text-based documents or spreadsheet documents, which contain information about current employees. Employee information, such as, names, education, qualification, experiences, etc., of each employee may be maintained in a corporate proprietary format using text-based documents. A user may then access the corporate source or sources of information items to obtain the names of employees having qualification or experiences that are needed at a particular time and place within the organization. The organization can therefore access the talent within the corporation, company, or firm, no matter where that talent resides.

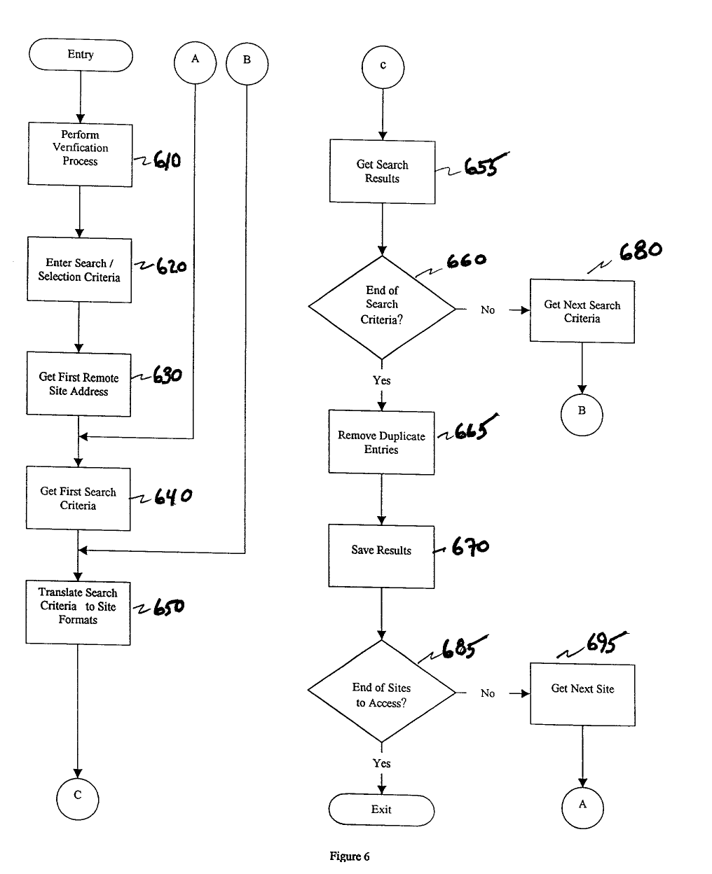

FIG. 6 illustrates a flow chart depicting processing in accordance with the principles of the present invention. At block 610, verification software, similar to that illustrated in FIG. 5b, is performed. After successful verification, the user is afforded the opportunity to enter search/selection criteria and designate at least one source to be searched at block 620. A first source is automatically selected at block 630 and a first/next search criteria is selected at block 640. At block 650 the selected search criteria is translated into a format acceptable by the selected source. After the selected search criteria have been processed by the selected source, the search results are processed at block 655. At block 660, a determination is made whether the end of the search criteria has been reached. If not, the next search criteria is selected at block 680 and translated into a format acceptable to the selected source at block 650.

If, however, the answer is in the affirmative, then duplicate entries are removed from the accumulated search results at block 665 and saved at block 670. At block 685, a determination is made whether each of the designated sources have been accessed. If not, then the next source is automatically selected at block 695 and a first search criteria is selected at block 640. Otherwise, the processing is completed.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed. It is intended that the patent shall cover by suitable expression in the appended claims, those features of patentable novelty that exist in the invention disclosed.

We claim:

1. A method for selectively retrieving information items from at least one source of said information items, said method comprising the steps of:
receiving at least one selection criteria at a local site;
expanding said at least one received selection criteria into a plurality of selection criteria, wherein each element in said at least one selection criteria is expanded using known variations of said element;
translating each of said selection criteria into a format acceptable to said at least one source of information items;
retrieving information items matching said selection criteria elements; and
storing said retrieved information items at said local site.

2. The method as recited in claim 1 wherein the step of storing retrieved information items further comprises the step of:
removing repeated retrieved information items such that only a single one of each retrieved information item is stored.

3. The method as recited in claim 1 wherein the step of retrieving further comprises the steps of:
transmitting each of said translated selection criteria to each of said at least one source of information items; and
receiving information items matching said selection criteria located at each of said at least one source of information items.

4. The method as recited in claim 3 further comprising the step of transmitting an access sequence over a communication network to each of said at least one source of information items, when said at least one source of information items requires said access sequence.

5. The method as recited in claim 3 wherein said information items located at said at least one source of information items are text documents.

6. The method as recited in claim 1 wherein said retrieving means comprise the steps of:
accessing a plurality of information item documents stored at said local site;
extracting information items matching said selection criteria located in said information item documents; and
receiving said matching information items.

7. The method as recited in claim 6 wherein said information item documents are text documents.

8. The method as recited in claim 6 wherein said information item documents are workbook files.

9. The method as recited in claim 2 wherein the step of removing repeated information items includes comparing retrieved information items using at least one matching criteria selected from the group consisting of name, address, telephone number, facsimile number and e-mail address.

10. The method as recited in claim 1 further comprising the step of inputting an access sequence for each of said at least one source requiring an access sequence.

11. The method as recited in claim 10 wherein said access sequence includes a login name.

12. The method as recited in claim 10 wherein said access sequence further includes a password.

13. The method as recited in claim I further comprising the step of determining a user's ability to enter selection criteria at said local site by requiring a verifying sequence.

14. The method as recited in claim 13 wherein said verifying sequence includes a login name.

15. The method as recited in claim 14 wherein said verifying sequence further includes a password.

16. The method as recited in claim 13 further comprising the steps of:
transmitting said verifying sequence over said communication network;
validating said verifying sequence at a designated remote site; and
providing an unlock sequence to said local site.

17. The method as recited in claim 1 further comprising the step of displaying said received selection criteria and said expanded selection criteria at said local site.

18. The method as recited in claim I wherein the step of expanding further comprises:
decomposing each of said at least one search criteria into search term elements and logical operations;
replacing each of said search term elements with at least one known variation of said term element; and
generating a next search criteria for each of said known search term variations wherein the order of said search terms variations and logical operations is maintained.

19. A system for selectively retrieving information items from at least one source of said information items, said system comprising:
a processing apparatus operative to:
receive at least one selection criteria at a local site;
expand said at least one received selection criteria into a plurality of selection criteria, wherein each element in said at least one selection criteria is expanded using known variations of said element;
translate each of said selection criteria into a format acceptable to said at least one source of information items;
retrieve information items matching said selection criteria elements; and
store said retrieved information items at said local site.

20. The system as recited in claim 19 wherein said processor apparatus is further operative to remove repeated retrieved information items such that only a single one of each retrieved information item is stored.

21. The system as recited in claim 19 wherein said processor apparatus is further operative to:
transmit each of said translated selection criteria to said at least one source of information items accepting said translated selection criteria format; and
receive information items matching said selection criteria elements located at each of said at least one source of information items.

22. The system as recited in claim 21 wherein said processor apparatus is further operative to transmit an access sequence over a communication network to each of said at least one source of information items, when said source of said information items requires said access sequence.

23. The system as recited in claim 22 wherein said information items located at said at least one source of information items are text documents.

24. The system as recited in claim 20 wherein said processor apparatus is further operative to:
access a plurality of information item documents stored at said local site;
extract information items matching said selection criteria located in said locally-stored information item documents; and
receive said matching information items.

25. The system as recited in claim 24 wherein said information item documents are text documents.

26. The system as recited in claim 24 wherein said information item documents are workbook files.

27. The system as recited in claim 21 wherein removing repeated information items includes comparing retrieved information items using at least one matching criteria selected from the group consisting of name, address, telephone number, facsimile number and e-mail address.

28. The system as recited in claim 20 wherein said processor apparatus is further operative to:
receive an access sequence for each of said at least one source of information items when said source requires said access sequence; and
transmit a corresponding access sequence to a corresponding source of information items, when said corresponding source requires said access sequence.

29. The system as recited in claim 28 wherein said access sequence includes a login name.

30. The system as recited in claim 29 further includes a password.

31. The system as recited in claim 20 wherein said processor apparatus is further operative to receive a verifying sequence.

32. The system as recited in claim 31 wherein said verifying sequence includes a login name.

33. The system as recited in claim 32 wherein said verifying sequence further includes a password.

34. The system as recited in claim 31 wherein said processor apparatus is further operative to:
transmit said verifying sequence over a communication network;
validate said verifying sequence at a designated remote site; and
receive an unlock sequence wherein said unlock sequence enables said processor to receive said selection criteria.

35. The system as recited in claim 20 wherein said processor apparatus is further operative to display said received selection criteria and said expanded selection criteria at said local site.

36. The system as recited in claim 20 wherein said processor is firther operative to:
decompose each of said at least one search criteria into search term elements and logical operations;
replace each of said search term elements with at least one known variation of said term; and
generate a next search criteria for each of said known search term variations wherein the order of said varied search term and logical operations is maintained.

37. A method of determining access to a software program executable at a local computer location, said method comprising the steps of:
receive a verifying sequence;
transmitting said verifying sequence over a communication network to a designated remote site;
validating said verifying sequence at said designated remote site; and
providing an unlock sequence to said local site when said verifying sequence is accepted.

38. The method as recited in claim 37 wherein said verifying sequence includes a login name.

39. The method as recited in claim 38 wherein said verifying sequence further includes a password.

40. The method as recited in claim 37 wherein said verifying sequence is encrypted prior to transmission to said designated remote site.

41. The method as recited in claim 37 further comprising enabling access to said software program operation when said unlock sequence is accepted.

42. The method as recited in claim 37 further comprising preventing access to said software program operation until said unlock sequence is received.

43. The method as recited in claim 37 wherein the step of verifying includes comparing said verifying sequence with known sequences.

44. A method for expanding search criteria and for retrieving information items contained on at least one source of said information items, said method comprising the steps of:
receiving at least one selection criteria at a local site;
expanding said at least one received selection criteria into a plurality of selection criteria, wherein each element in said at least one selection criteria is expanded using known variations of said element;
translating each of said selection criteria into a format acceptable to said at least one source of information items;
retrieving information items matching said selection criteria elements; and
storing said retrieved information items at said local site.

45. The method as recited in claim 44 wherein the step of storing retrieved information items further comprises the step of removing repeated retrieved information items wherein only a single one of each retrieved information item is stored.

46. The method as recited in claim 44 wherein the step of retrieving further comprises the steps of:
transmitting each of said translated selection criteria to each of said at least one source of information items; and
receiving information items matching said selection criteria located at each of said at least one source of information items.

47. The method as recited in claim 46 wherein the step of retrieving further comprises the step of transmitting an access sequence over a communication network, to each of said at least one source of information items, when said at least one source of information items requires said access sequence.

48. The method as recited in claim 47 wherein said information items located at said at least one source of information items are text documents.

49. The method as recited in claim 45 wherein said retrieving means comprise the steps of:
accessing a plurality of information item documents stored at said local site;
extracting information items matching said selection criteria located in said information item documents; and
receiving said matching information items.

50. The method as recited in claim 49 wherein said information item documents are text documents.

51. The method as recited in claim 49 wherein said information item documents are workbook files.

52. The method as recited in claim 45 wherein the step of removing repeated information items includes comparing retrieved information items using at least one matching criteria selected from the group consisting of name, address, telephone number, facsimile number and e-mail address.

53. The method as recited in claim 45 further comprising the step of inputting an access sequence for each of said at least one source requiring an access sequence.

54. The method as recited in claim 53 wherein said access sequence includes a login name.

55. The method as recited in claim 53 further includes a password.

56. The method as recited in claim 43 further comprising the step of determining a user's ability to enter selection criteria at said local site by requiring a verifying sequence.

57. The method as recited in claim 56 wherein said verifying sequence includes a login name.

58. The method as recited in claim 57 wherein said verifying sequence further includes a password.

59. The method as recited in claim 56 further comprising the steps of:
transmitting said verifying sequence over said communication network;
validating said verifying sequence at a designated remote site; and
providing an unlock sequence to said local site.

60. The method as recited in claim 44 further comprising the step of displaying said inputted selection criteria and said expanded selection criteria at said local site.

61. The method as recited in claim 44 wherein the step of expanding selection criteria further comprises:
decomposing each of said at least one search criteria into search term elements and logical operations;
replacing each of said search term elements with at least one known variation of said term element; and
generating a next search criteria for each of said known search term variations wherein the order of said search terms variations and logical operations is maintained.

62. The method as recited in claim 44 wherein said information items are employment positions.

63. The method as recited in claim 44 wherein said information items are resumes.

64. The method as recited in claim 44 wherein said information items are employee qualification files.
